(19) United States
(12) Patent Application Publication
(10) Pub. No.: US 2022/0339893 A1
(43) Pub. Date: Oct. 27, 2022

(54) PRESSURE VESSEL AND METHOD OF MANUFACTURING THE SAME

(71) Applicants: Hyundai Motor Company, Seoul (KR); Kia Corporation, Seoul (KR)

(72) Inventor: Dong Sun LEE, Whasung-Si (KR)

(73) Assignees: Hyundai Motor Company, Seoul (KR); Kia Corporation, Seoul (KR)

(21) Appl. No.: 17/492,472

(22) Filed: Oct. 1, 2021

(30) Foreign Application Priority Data
Apr. 23, 2021 (KR) 10-2021-0053332

(51) Int. Cl. B29C 70/78; B29C 70/32; F17C 1/06

(52) U.S. Cl. CPC B29C 70/78; B29C 70/32; F17C 1/06; B29K 2705/02

(57) ABSTRACT

A method of manufacturing a pressure vessel, may include a preparation step of preparing a boss made of metal; a processing step of processing a concave-convex pattern on an external surface of the boss; and a winding step of winding a reinforcing material around an external surface of a liner including the boss so that the reinforcing material is disposed on the concave-convex pattern, improving quality and durability of the pressure vessel and reducing a defect rate.

### CROSS-REFERENCE TO RELATED APPLICATION

The present application claims priority to Korean Patent Application No. 10-2021-0053332 filed on Apr. 23, 2021, the entire contents of which is incorporated herein for all purposes by this reference.

### BACKGROUND OF THE INVENTION

### Field of the Invention

The present invention relates to a pressure vessel and a method of manufacturing the same, and more particularly, to a pressure vessel capable of improving quality and durability thereof and reducing a defect rate thereof, and a method of manufacturing the pressure vessel.

### Description of Related Art

A hydrogen vehicle is configured to produce electricity by a chemical reaction between hydrogen and oxygen and to travel by operating a motor. More specifically, the hydrogen vehicle includes a hydrogen tank (H₂ tank) configured to store hydrogen (H₂), a fuel cell stack configured to produce electricity by an oxidation-reduction reaction between hydrogen and oxygen (O₂), various types of devices configured to discharge produced water, a battery configured to store the electricity produced by the fuel cell stack, a controller configured to convert and control the produced electricity, and a motor configured to generate driving power.

Meanwhile, a TYPE 4 pressure vessel may be used as the hydrogen tank of the hydrogen vehicle. The TYPE 4 pressure vessel includes a liner (e.g., a nonmetallic material), and a carbon fiber layer made by winding a carbon fiber composite material around an external surface of the liner.

Generally, however, because the carbon fiber composite material slips during the process of winding the carbon fiber composite material around the external surface of the liner, it is difficult to accurately wind the carbon fiber composite material in a required posture and at a required position.

Furthermore, when the carbon fiber composite material slips during the process of winding the carbon fiber composite material, it is necessary to stop the process of winding the carbon fiber composite material, remove a portion in which the carbon fiber composite material is erroneously wound, and then rewind the carbon fiber composite material at a redesigned winding angle. For the present reason, there are problems in that manufacturing efficiency deteriorates, manufacturing costs increase, and quality and durability of the pressure vessel are difficult to ensure.

Therefore, recently, various studies are conducted to improve the quality and durability of the pressure vessel and reduce the defect rate, but the study results are still insufficient. Accordingly, there is a need to develop a technology for improving the quality and durability of the pressure vessel and reducing the defect rate.

The information disclosed in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a pressure vessel configured for improving quality and durability thereof and reducing a defect rate thereof, and a method of manufacturing the pressure vessel.

The present invention, in various aspects, has also been made in an effort to minimize slipping of a reinforcing material (e.g., carbon fiber) during a process of winding the reinforcing material and accurately wind the reinforcing material in a required posture and at a required position.

The present invention, in various aspects, has also been made in an effort to simplify a manufacturing process and reduce manufacturing time.

The present invention, in various aspects, has also been made in an effort to improve manufacturing efficiency and reduce costs.

The present invention, in various aspects, has also been made in an effort to increase strength of a boss without changing a structure of the boss.

The objects to be achieved by the exemplary embodiments are not limited to the above-mentioned objects, but also include objects or effects which may be understood from the solutions or embodiments described below.

Various aspects of the present invention provide a pressure vessel including: a liner having a boss made of metal and provided at an end portion of the liner; a concave-convex pattern provided on an external surface of the boss; and a reinforcing material wound around an external surface of the liner so that the reinforcing material is disposed on the concave-convex pattern.

This is to improve quality and durability of the pressure vessel and reduce a defect rate.

That is, generally, because a carbon fiber composite material slips during a process of winding the carbon fiber composite material around an external surface of a liner, it is difficult to accurately wind the carbon fiber composite material in a required posture and at a required position.

Furthermore, when the carbon fiber composite material slips during the process of winding the carbon fiber composite material, it is necessary to stop the process of winding the carbon fiber composite material, remove a portion in which the carbon fiber composite material is erroneously wound, and then rewind the carbon fiber composite material at a redesigned winding angle. For the present reason, there are problems in that manufacturing efficiency deteriorates, manufacturing costs increase, and quality and durability of the pressure vessel are difficult to ensure.

However, according to the exemplary embodiment of the present invention, the concave-convex pattern may be provided on the external surface of the boss provided in the liner, and the reinforcing material may be wound to be disposed on the concave-convex pattern. Therefore, it is possible to obtain an advantageous effect of minimizing the slipping of the reinforcing material, minimizing the winding defect, and accurately winding the reinforcing material in a required posture and at a required position.

According to the exemplary embodiment of the present invention, the concave-convex pattern may have various structures and shapes configured for increasing the surface roughness of the boss.

The concave-convex pattern may be made by plastically deforming the external surface of the boss.

The boss may be made of an aluminum alloy (e.g., AL6060-T6).

As described above, in the exemplary embodiment of the present invention, since the concave-convex pattern is provided on the external surface of the boss by plastically deforming the external surface of the boss, the concave-convex pattern may apply residual compressive stress (residual compressive force) to the external surface of the boss while preventing the slipping of the reinforcing material. Therefore, it is possible to obtain an advantageous effect of further increasing strength (fatigue strength) of the boss.

Among other things, according to the exemplary embodiment of the present invention, the boss may be made of an aluminum alloy, and the concave-convex pattern may be made by plastically deforming the external surface of the boss. Therefore, it is possible to make the surface tissue of the boss denser (finer) and thus inhibit a crack and deformation of the boss.

Furthermore, more complex hydrogen permeation paths may be implemented by making the surface tissue of the boss denser. Therefore, it is possible to obtain an advantageous effect of inhibiting diffusion (permeation movement) of hydrogen and inhibiting brittleness of the boss.

According to the exemplary embodiment of the present invention, the concave-convex pattern may include a plurality of crests and a plurality of troughs alternately disposed to define a continuous waveform therebetween.

Distances from a reference line, which is parallel to the external surface of the boss, to bottoms of the plurality of troughs may be equal to one another.

As described above, since the distances from the reference line to the bottoms of the troughs are equal to one another for the respective troughs, it is possible to obtain an advantageous effect of uniformly providing the entire concave-convex pattern with characteristics (e.g., the increase in strength) implemented by the plastic deformation.

According to the exemplary embodiment of the present invention, the distances from the reference line, which is parallel to the external surface of the boss, to the apices of the plurality of crests may be equal to one another.

According to the exemplary embodiment of the present invention, the distances from the reference line, which is parallel to the external surface of the boss, to the apices of at least some of the plurality of crests may be different from one another. As described above, since at least some of the crests are positioned at different heights, the surface roughness of the boss may further increase. Therefore, it is possible to obtain an advantageous effect of more effectively inhibiting the slipping of the reinforcing material.

According to the exemplary embodiment of the present invention, a depth h from the external surface of the boss to the bottom portion of the trough may be 0.04 mm to 0.15 mm.

As described above, since the depth h from the external surface of the boss to the bottom portion of the trough is 0.04 mm to 0.15 mm, it is possible to obtain an advantageous effect of inhibiting the deformation of and the damage to the boss while ensuring the sufficient strength and surface roughness of the boss (preventing the slipping of the reinforcing material).

In another aspect, various aspects of the present invention provide a method of manufacturing a pressure vessel, the method including: a preparation step of preparing a boss made of metal; a processing step of processing a concave-convex pattern on an external surface of the boss; and a winding step of winding a reinforcing material around an external surface of a liner including the boss so that the reinforcing material is disposed on the concave-convex pattern.

The boss may be made of an aluminum alloy (e.g., AL6060-T6).

According to the exemplary embodiment of the present invention, the concave-convex pattern may include a plurality of crests and a plurality of troughs alternately disposed to define a continuous waveform therebetween.

Distances from a reference line, which is parallel to the external surface of the boss, to bottoms of the plurality of troughs may be equal to one another.

According to the exemplary embodiment of the present invention, the distances from the reference line, which is parallel to the external surface of the boss, to the apices of the plurality of crests may be equal to one another.

According to the exemplary embodiment of the present invention, the distances from the reference line, which is parallel to the external surface of the boss, to the apices of at least some of the plurality of crests may be different from one another.

According to the exemplary embodiment of the present invention, the concave-convex pattern may be made by plastically deforming the external surface of the boss in the processing step.

For example, in the processing step, the concave-convex pattern may be provided by pressing the external surface of the boss with indentation protrusions provided on a peripheral surface of an indentation jig.

During a process of pressing the external surface of the boss with the indentation protrusions, the indentation jig may roll along the external surface of the boss or the boss may rotate about an axis of the liner, and at least any one of the rolling of the indentation jig and the rotation of the boss may be performed.

As various exemplary embodiments of the present invention, in the processing step, the concave-convex pattern may be provided by propelling shot balls against the external surface of the boss.

The boss may rotate about the axis of the liner during a process of propelling the shot balls against the external surface of the boss.

According to the exemplary embodiment of the present invention, a depth h from the external surface of the boss to the bottom portion of the trough may be 0.04 mm to 0.15 mm.

According to the exemplary embodiment of the present invention described above, it is possible to obtain an advantageous effect of improving quality and durability of the pressure vessel and reduce a defect rate.

According to the exemplary embodiment of the present invention, it is possible to obtain an advantageous effect of minimizing the slipping of the reinforcing material during the process of winding the reinforcing material and an advantageous effect of accurately winding the reinforcing material in a required posture and at a required position.

Furthermore, according to the exemplary embodiment of the present invention, it is possible to obtain an advantageous effect of simplifying a manufacturing process and reducing manufacturing time.

Furthermore, according to the exemplary embodiment of the present invention, it is possible to obtain an advantageous effect of improving manufacturing efficiency and reducing costs.

Furthermore, according to the exemplary embodiment of the present invention, it is possible to obtain an advantageous effect of increasing the strength of the boss without changing the structure of the boss.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart for explaining a method of manufacturing a pressure vessel according to various exemplary embodiments of the present invention.

FIG. 2 is a view for explaining the pressure vessel according to the exemplary embodiment of the present invention.

FIG. 3 is an enlarged view of part ‘A’ in FIG. 2.

FIG. 4 is a top plan view for explaining a concave-convex pattern in the pressure vessel according to the exemplary embodiment of the present invention.

FIG. 5 and FIG. 6 are views for explaining another example of the concave-convex pattern in the pressure vessel according to the exemplary embodiment of the present invention.

FIG. 7 and FIG. 8 are views for explaining yet another example of the concave-convex pattern in the pressure vessel according to the exemplary embodiment of the present invention.

FIG. 9 and FIG. 10 are views for explaining a process of processing the concave-convex pattern in the pressure vessel according to the exemplary embodiment of the present invention.

FIG. 11 and FIG. 12 are views for explaining another example of the process of processing the concave-convex pattern in the pressure vessel according to the exemplary embodiment of the present invention.

FIG. 13 is a view exemplarily illustrating an external surface of a boss on which a concave-convex pattern is provided in the pressure vessel according to the exemplary embodiment of the present invention.

FIG. 14 is a view for explaining a surface tissue structure of a boss on which a concave-convex pattern is provided by a cutting process in the pressure vessel according to the exemplary embodiment of the present invention.

FIG. 15 is a view for explaining a surface tissue structure of a boss on which a concave-convex pattern is provided by an indentation process in the pressure vessel according to the exemplary embodiment of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, embodiments of the present invention will be described in detail with reference to the accompanying drawings.

However, the technical spirit of the present invention is not limited to various exemplary embodiments described herein but may be implemented in various different forms. One or more of the constituent elements in the exemplary embodiments may be selectively combined and substituted for use within the scope of the technical spirit of the present invention.

Furthermore, unless otherwise specifically and explicitly defined and stated, the terms (including technical and scientific terms) used in the exemplary embodiments of the present invention may be construed as the meaning which may be commonly understood by the person with ordinary skill in the art to which various exemplary embodiments of the present invention pertains. The meanings of the commonly used terms such as the terms defined in dictionaries may be interpreted in consideration of the contextual meanings of the related technology.

Furthermore, the terms used in the exemplary embodiments of the present invention are for explaining the embodiments, not for limiting the present invention.

In the present specification, unless particularly stated otherwise, a singular form may also include a plural form. The expression “at least one (or one or more) of A, B, and C” may include one or more of all combinations that may be made by combining A, B, and C.

Furthermore, the terms such as first, second, A, B, (a), and (b) may be used to describe constituent elements of the exemplary embodiments of the present invention.

These terms are used only for discriminating one constituent element from another constituent element, and the nature, the sequences, or the orders of the constituent elements are not limited by the terms.

Furthermore, when one constituent element is referred to as being ‘connected’, ‘coupled’, or ‘attached’ to another constituent element, one constituent element may be connected, coupled, or attached directly to another constituent element or connected, coupled, or attached to another constituent element through yet another constituent element interposed therebetween.

Furthermore, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

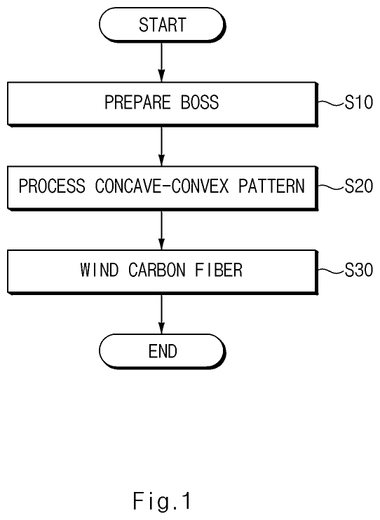

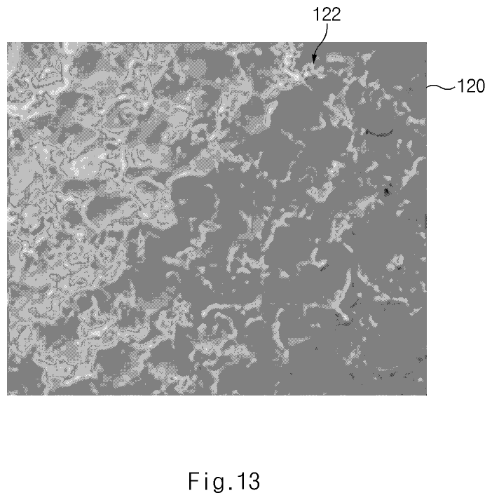

Referring to FIGS. 1 to 15, a pressure vessel 100 according to various exemplary embodiments of the present invention includes a liner 110 having bosses 120 made of metal and provided at end portions of the liner 110, a concave-convex pattern 122 provided on an external surface of each of the bosses 120, and a reinforcing material 130 wound around an external surface of the liner 110 to be disposed on the concave-convex pattern 122.

For reference, the pressure vessel 100 according to the exemplary embodiment of the present invention may be used to store a high-pressure fluid (liquid or gas), and the present invention is not restricted or limited by the type and property of the fluid to be stored in the pressure vessel 100.

Hereinafter, an example will be described in which the pressure vessel 100 according to the exemplary embodiment of the present invention is used as a hydrogen tank for a hydrogen storage system applied to mobility vehicles such as various fuel cell vehicles (e.g., passenger vehicles or commercial vehicles), ships, and aircrafts to which a fuel cell stack may be applied.

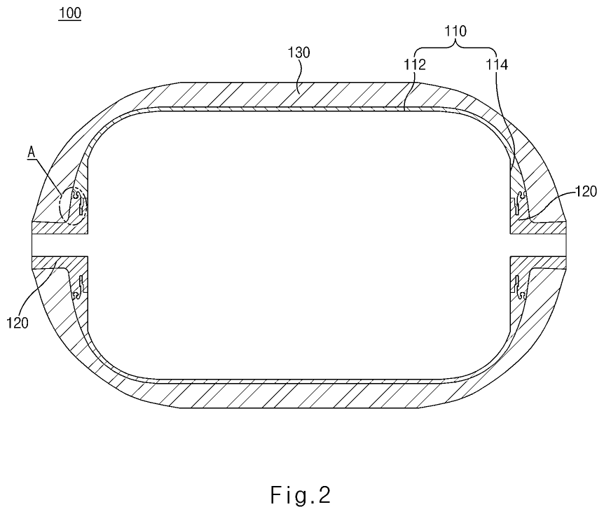

Referring to FIG. 2, the liner 110 may have a hollow structure having a storage space therein, and high-pressure compressed hydrogen may be stored in the storage space.

The bosses 120 made of metal are provided at the end portions of the liner 110, respectively. The bosses 120 have inlet and outlet ports, respectively, and the hydrogen is introduced through the inlet port and discharged through the outlet port.

Hereinafter, an example will be described in which the bosses 120 are provided at two opposite end portions of the liner 110, respectively. According to various exemplary embodiments of the present invention, the boss may be provided only at one end portion of the liner.

The material of the liner 110 may be variously changed in accordance with required conditions and design specifications, and the present invention is not limited or restricted by the material of the liner 110. The liner 110 may be made of a nonmetallic material such as high-density plastic with excellent restoring force and excellent fatigue resistance.

The liner 110 may include a cylinder portion 112 having a hollow cylindrical shape, and dome-shaped side portions 114 integrated with the cylinder portion 112 at the two opposite end portions of the cylinder portion 112. The bosses 120 may be provided to define outermost peripheries of the side portions 114, respectively.

The boss 120 may have a hollow cylindrical shape having a flange provided at one end portion thereof, and the present invention is not restricted or limited by the structure and shape of the boss.

The boss 120 may be made of various types of metal materials in accordance with required conditions and design specifications, and the present invention is not restricted or limited by the material of the boss 120.

The boss 120 may be made of an aluminum alloy (e.g., AL6060-T6).

A reinforcing layer may be made by winding the reinforcing material 130 around the external surface of the liner 110.

For reference, the reinforcing material 130 is provided such that the pressure vessel 100 may withstand high pressure well. The reinforcing material 130 is provided (wound) to surround the entire external surface of the liner 110.

According to the exemplary embodiment of the present invention, a carbon fiber composite material impregnated with epoxy and thermosetting resin may be provided as the reinforcing material 130, and the present invention is not restricted or limited by the material and property of the reinforcing material. According to various exemplary embodiments of the present invention, a structure for and a method of winding the fiberglass and the reinforcing material 130 may be variously changed in accordance with required conditions and design specifications, and the present invention is not restricted or limited by the method of winding the reinforcing material 130. For example, the reinforcing layer may be made by winding a plurality of layers of the reinforcing material 130 around the external surface of the liner 110 in various patterns (e.g., clockwise winding, counterclockwise winding, oblique winding, etc.).

The reinforcing material 130 is cured through a subsequent heat treatment process and thus is made as the reinforcing layer. For example, the reinforcing material 130 wound around the external surface of the liner 110 may be cured through the heat treatment at a temperature of 150° C. or higher for a predetermined time period.

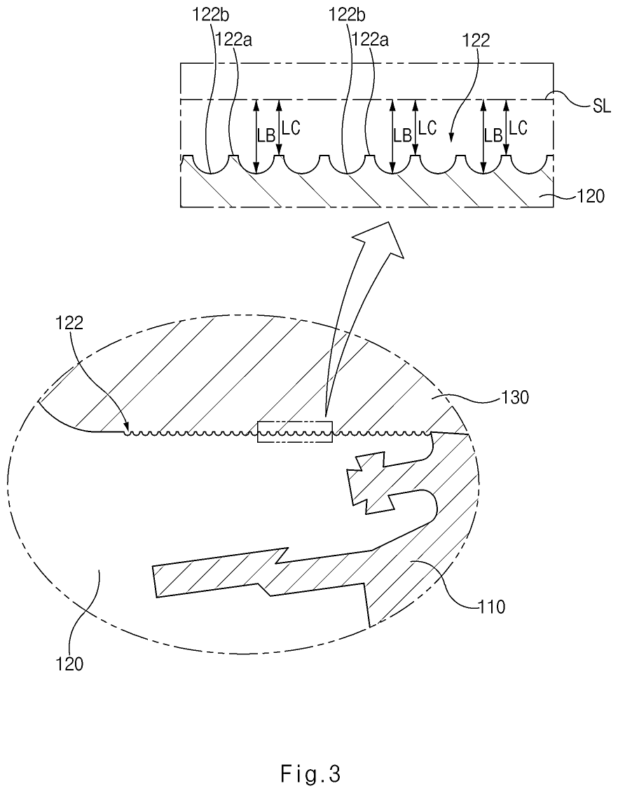

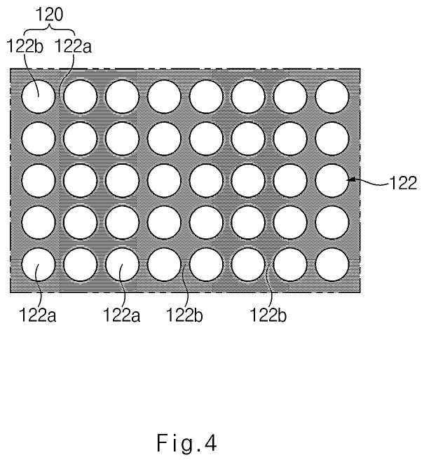

Referring to FIG. 3 and FIG. 4, the concave-convex pattern 122 is provided to minimize the slipping of the reinforcing material 130 on the external surface of the liner 110 during the process of winding the reinforcing material 130 around the external surface of the liner 110.

This is based on the fact that the reinforcing material 130 frequently slips during the process of winding the reinforcing material 130 around the external surface of the side portion 114 having a spherical surface. The surface roughness of the boss 120 may be increased by the concave-convex pattern 122 provided on the external surface of the boss 120 provided in the side portion, which makes it possible to minimize the slipping of the reinforcing material 130 (minimizing a winding defect). Therefore, it is possible to obtain an advantageous effect of accurately winding the reinforcing material 130 in a required posture and at a required position.

The concave-convex pattern 122 may have various structures and shapes capable of increasing the surface roughness of the boss 120, and the present invention is not restricted or limited by the structure and shape of the concave-convex pattern 122.

The concave-convex pattern 122 may be made by plastically deforming the external surface of the boss 120.

For example, the concave-convex pattern 122 may include plastically deforming the external surface of the boss 120 through an indentation process.

As described above, in the exemplary embodiment of the present invention, since the concave-convex pattern 122 may be provided on the external surface of the boss 120 by plastically deforming the external surface of the boss 120 through the indentation process, the concave-convex pattern 122 may apply residual compressive stress (residual compressive force) to the external surface of the boss 120 while preventing the slipping of the reinforcing material 130. Therefore, it is possible to obtain an advantageous effect of further increasing strength (fatigue strength) of the boss 120.

Among other things, according to the exemplary embodiment of the present invention, the boss 120 may be made of an aluminum alloy (e.g., AL6060-T6), and the concave-convex pattern 122 may be made by plastically deforming the external surface of the boss 120. Therefore, it is possible to make the surface tissue of the boss 120 denser (finer) and thus inhibit a crack and deformation of the boss 120.

Furthermore, more complex hydrogen permeation paths may be implemented by making the surface tissue of the boss 120 denser. Therefore, it is possible to obtain an advantageous effect of inhibiting diffusion (permeation movement) of hydrogen and inhibiting brittleness of the boss 120 caused by the hydrogen.

Meanwhile, according to various exemplary embodiments of the present invention, the concave-convex pattern 122 may be provided on the external surface of the boss 120 by cutting the external surface of the boss 120. However, the surface tissue of the boss 120 having the concave-convex pattern 122 provided by the cutting process hardly has a high density compared to the surface tissue of the boss 120 having the concave-convex pattern 122 provided by an indentation process.

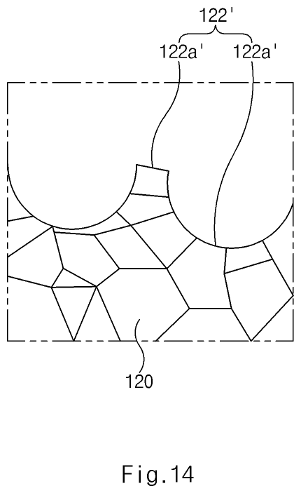

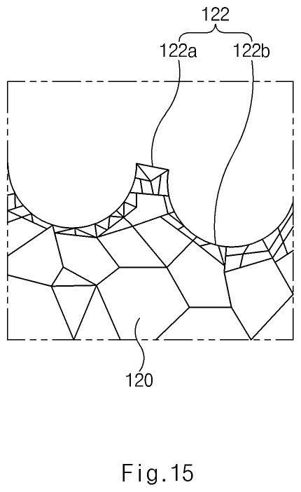

For reference, FIG. 14 illustrates the surface tissue structure of the boss 120 having a concave-convex pattern 122′ provided by the cutting process, and FIG. 15 illustrates the surface tissue structure of the boss 120 having the concave-convex pattern 122 provided by the indentation process.

It may be ascertained, by comparing FIG. 14, and FIG. 15, that the surface tissue of the boss 120 having the concave-convex pattern 122 provided by the indentation process is denser than the surface tissue of the boss 120 having the concave-convex pattern 122′ provided by the cutting process.

Meanwhile, the boss may be made of steel, and the concave-convex pattern may be provided on a surface of the boss made of steel. However, the surface tissue of the boss (made of steel) having the concave-convex pattern provided by the indentation process is not greatly different from the surface tissue of the boss (made of steel) having the concave-convex pattern provided by the cutting process. Therefore, the aluminum alloy may be used as the material of the boss.

According to the exemplary embodiment of the present invention, the concave-convex pattern 122 may include a plurality of crests 122a and a plurality of troughs 122b alternately disposed to define a continuous waveform therebetween.

The arrangement pattern of the crests 122a and the troughs 122b may be variously changed in accordance with required conditions and design specifications, and the present invention is not restricted or limited by the arrangement pattern of the crests 122a and the troughs 122b.

For example, the crests 122a and the troughs 122b may be arranged in a regular arrangement pattern. Alternatively, the crests 122a and the troughs 122b may be arranged in an irregular (random) arrangement pattern.

Distances LB from a reference line SL, which is parallel to the external surface of the boss 120, to bottoms of the plurality of troughs 122b may be equal to one another.

As described above, since the distances LB from the reference line SL to the bottoms of the troughs 122b are equal to one another for the respective troughs 122b, it is possible to obtain an advantageous effect of uniformly providing the entire concave-convex pattern 122 with characteristics (e.g., the increase in strength) implemented by the plastic deformation.

Referring to FIG. 3 and FIG. 4, according to the exemplary embodiment of the present invention, distances from the reference line SL, which is parallel to the external surface of the boss 120, to apices of the plurality of crests 122a may be equal to one another.

In the instant case, the configuration in which the distances from the reference line SL to the apices of the plurality of crests 122a are equal to one another may be understood as a configuration in which the crests 122a and the troughs 122b are arranged in a regular arrangement pattern so that the apices of the respective crests 122a are positioned at the same height.

For example, based on the projection plane (based on FIG. 4), the plurality of troughs 122b may have circular shapes having the same diameter and be spaced from one another at predetermined intervals. The crests 122a may be disposed to each define a boundary between the adjacent troughs 122b.

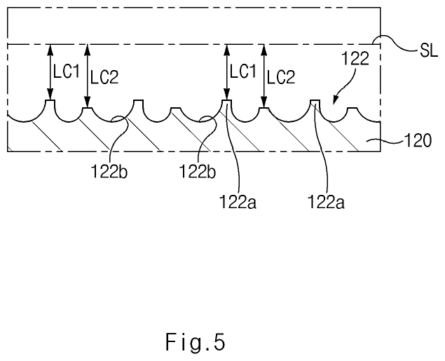

Referring to FIGS. 5 to 8, according to various exemplary embodiments of the present invention, distances (e.g., LC1 and LC2) from the reference line SL, which is parallel to the external surface of the boss 120, to apices of at least some of the plurality of crests 122a may be different from one another.

As described above, since at least some of the crests 122a are positioned at different heights, the surface roughness of the boss 120 may further increase. Therefore, it is possible to obtain an advantageous effect of more effectively inhibiting the slipping of the reinforcing material 130.

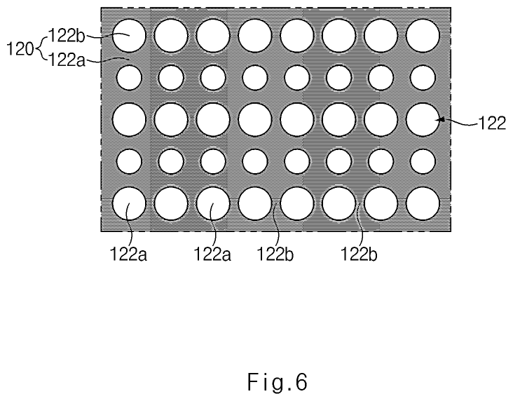

For example, referring to FIG. 5 and FIG. 6, some of the plurality of crests 122a may each have a first distance LC1 from the reference line SL to the apex thereof, and the other crests 122a may each have a second distance LC2 from the reference line SL to the apex thereof. The second distance LC2 may be longer than the first distance LC1 (LC2 >LC1).

The crests 122a each having the first distance LC1 and the crests 122a each having the second distance LC2 may be disposed alternately (regularly) in a particular direction (e.g., a left and right direction based on FIG. 6).

For example, based on the projection plane (based on FIG. 6), the plurality of troughs 122b may have circular shapes having different diameters and be spaced from one another at different intervals. The crests 122a may be disposed to each define a boundary between the adjacent troughs 122b.

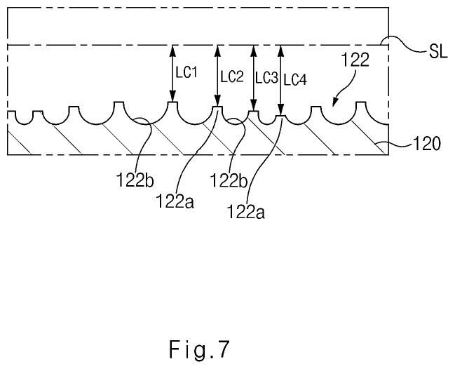

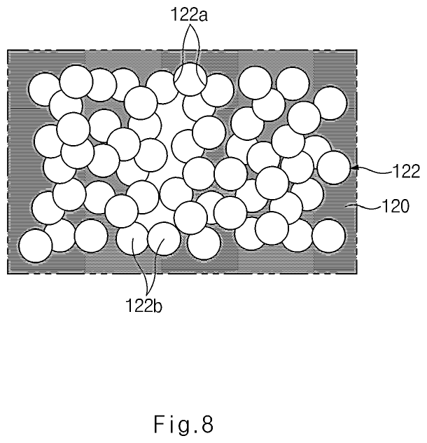

As various exemplary embodiments of the present invention, referring to FIGS. 7 and 8, all the distances LC1, LC2, LC3, and LC4 from the reference line SL to the apices of the plurality of crests 122a may be different from one another (LC1≠LC2≠LC3≠LC4).

For example, based on the projection plane (based on FIG. 8), the plurality of troughs 122b may have circular shapes having the same diameter and be disposed to randomly and partially overlap one another. The crests 122a may be disposed to each define a boundary between the adjacent troughs 122b.

The concave-convex pattern 122 may be provided (processed) in various ways in accordance with required conditions and design specifications.

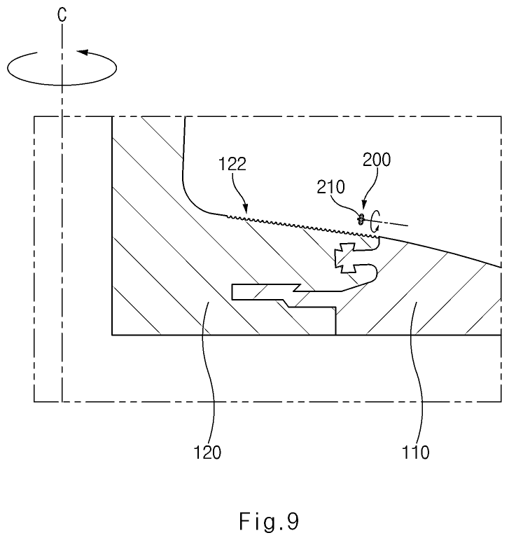

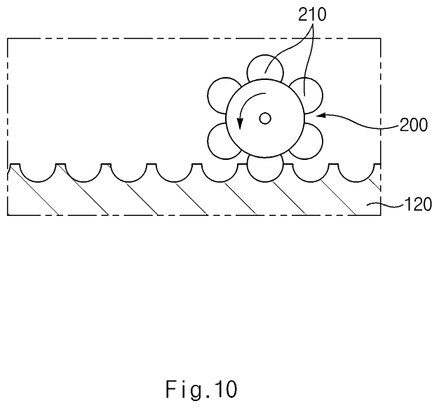

For example, referring to FIG. 9 and FIG. 10, the concave-convex pattern 122 may be provided by pressing the external surface of the boss 120 with indentation protrusions 210 (e.g., indentation protrusions each having a hemispheric shape) provided on a peripheral surface of an indentation jig 200.

During the process of pressing the external surface of the boss 120 with the indentation protrusions 210, the indentation jig 200 may roll along the external surface of the boss 120 or the boss 120 may rotate about an axis C of the liner 110. At least any one of the rolling of the indentation jig 200 and the rotation of the boss 120 may be performed. For example, during the process of pressing the external surface of the boss 120 with the indentation protrusions 210, the indentation jig 200 may roll along the external surface of the boss 120, and at the same time, the boss 120 may rotate about the axis C of the liner 110.

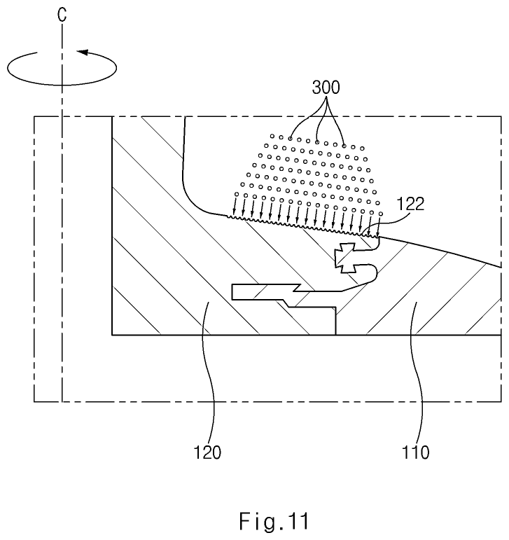

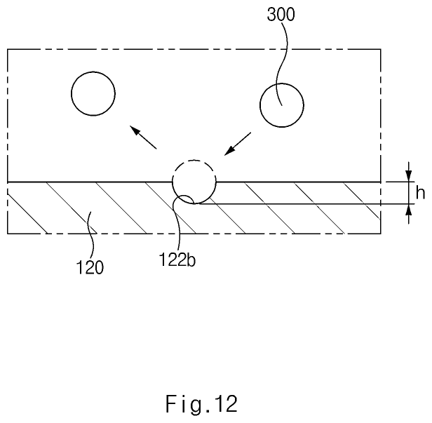

As various exemplary embodiments of the present invention, referring to FIG. 11 and FIG. 12, the concave-convex pattern 122 may be provided by propelling shot balls 300, which are rigid bodies, against the external surface of the boss 120.

A diameter of the shot ball 300 may be variously changed in accordance with required conditions and design specifications, and the present invention is not restricted or limited by the diameter of the shot ball 300. For example, a shot ball 300 having a diameter of 0.8 mm or a shot ball 300 having a diameter of 1 mm may be used.

The boss 120 may rotate about the axis C of the liner 110 during the process of propelling the shot balls 300 against the external surface of the boss 120.

According to the exemplary embodiment of the present invention, a depth h from the external surface of the boss 120 to the bottom portion of the trough 122b may be 0.04 mm to 0.15 mm.

As described above, since the depth h from the external surface of the boss 120 to the bottom portion of the trough 122b is 0.04 mm to 0.15 mm, it is possible to obtain an advantageous effect of inhibiting the deformation of and the damage to the boss 120 while ensuring the sufficient strength and surface roughness of the boss 120 (preventing the slipping of the reinforcing material).

That is, if the depth h from the external surface of the boss 120 to the bottom portion of the trough 122b is smaller than 0.04 mm, it is difficult to implement sufficient plastic deformation, ensure sufficient strength of the boss 120, and ensure a sufficient height of the crest 122a (a sufficient distance from the reference line to the apex of the crest 122a). Therefore, there is a problem in that it is difficult to ensure sufficient surface roughness of the boss 120. In contrast, if the depth h from the external surface of the boss 120 to the bottom portion of the trough 122b is greater than 0.15 mm, there is a problem in that a crack is generated in the external surface of the boss 120, which causes a deterioration in strength of the boss 120.

Therefore, the depth h from the external surface of the boss 120 to the bottom portion of the trough 122b may be 0.04 mm to 0.15 mm.

Hereinafter, a method of manufacturing a pressure vessel according to various exemplary embodiments of the present invention will be described.

Referring to FIG. 1, the method of manufacturing a pressure vessel according to various exemplary embodiments of the present invention includes: a preparation step of preparing the boss 120 made of metal; a processing step of processing the concave-convex pattern 122 on the external surface of the boss 120; and a winding step of winding the reinforcing material 130 around the external surface of the liner 110 including the boss 120 so that the reinforcing material 130 is disposed on the concave-convex pattern 122.

STEP 1:

First, the boss 120 made of metal is provided (S10).

For example, in the preparation step S10, the boss 120 made of metal may be provided in a state of being separated from the liner (see 110 in FIG. 2).

The boss 120 may have various structures configured for being connected to a tube, a valve, or the like, and the present invention is not restricted or limited by the structure of the boss 120.

The boss 120 may be made of an aluminum alloy (e.g., AL6060-T6).

STEP 2:

Next, the concave-convex pattern 122 is processed on the external surface of the boss 120.

In the processing step S20, the concave-convex pattern 122 may be provided on the external surface of the boss 120 by processing the external surface of the boss 120.

The concave-convex pattern 122 may have various structures and shapes capable of increasing the surface roughness of the boss 120.

For example, the concave-convex pattern 122 may include the plurality of crests 122a and the plurality of troughs 122b alternately disposed to define a continuous waveform therebetween.

The arrangement pattern of the crests 122a and the troughs 122b may be variously changed in accordance with required conditions and design specifications, and the present invention is not restricted or limited by the arrangement pattern of the crests 122a and the troughs 122b.

For example, the crests 122a and the troughs 122b may be arranged in a regular arrangement pattern. Alternatively, the crests 122a and the troughs 122b may be arranged in an irregular (random) arrangement pattern.

The distances LB from the reference line SL, which is parallel to the external surface of the boss 120, to the bottoms of the plurality of troughs 122b may be equal to one another (see FIG. 3).

As described above, since the distances LB from the reference line SL to the bottoms of the troughs 122b are equal to one another for the respective troughs 122b, it is possible to obtain an advantageous effect of uniformly providing the entire concave-convex pattern 122 with characteristics (e.g., the increase in strength) implemented by the plastic deformation.

According to the exemplary embodiment of the present invention, the distances from the reference line SL, which is parallel to the external surface of the boss 120, to the apices of the plurality of crests 122a may be equal to one another (see FIG. 3).

According to various exemplary embodiments of the present invention, the distances from the reference line SL, which is parallel to the external surface of the boss 120, to the apices of at least some of the plurality of crests 122a may be different from one another.

For example, referring to FIG. 5 and FIG. 6, some of the plurality of crests 122a may each have the first distance LC1 from the reference line SL to the apex thereof, and the other crests 122a may each have the second distance LC2 from the reference line SL to the apex thereof. The second distance LC2 may be longer than the first distance LC1 (LC2 >LC1).

As various exemplary embodiments of the present invention, referring to FIGS. 7 and 8, all the distances LC1, LC2, LC3, and LC4 from the reference line SL to the apices of the plurality of crests 122a may be different from one another (LC1≠LC2≠LC3≠LC4).

According to the exemplary embodiment of the present invention, the concave-convex pattern 122 may be made by plastically deforming the external surface of the boss 120 through the indentation process in the processing step.

For example, in the processing step S20, the concave-convex pattern 122 may be provided by pressing the external surface of the boss 120 with the indentation protrusions 210 (e.g., the indentation protrusions each having a hemispheric shape) provided on the peripheral surface of the indentation jig 200.

During the process of pressing the external surface of the boss 120 with the indentation protrusions 210, the indentation jig 200 may roll along the external surface of the boss 120 or the boss 120 may rotate about the axis C of the liner 110. At least any one of the rolling of the indentation jig 200 and the rotation of the boss 120 may be performed.

As various exemplary embodiments of the present invention, in the processing step S20, the concave-convex pattern 122 may be provided by propelling the shot balls 300, which are rigid bodies, against the external surface of the boss 120.

The boss 120 may rotate about the axis C of the liner 110 during the process of propelling the shot balls 300 against the external surface of the boss 120.

According to the exemplary embodiment of the present invention, the depth h from the external surface of the boss 120 to the bottom portion of the trough 122b may be 0.04 mm to 0.15 mm.

As described above, since the depth h from the external surface of the boss 120 to the bottom portion of the trough 122b is 0.04 mm to 0.15 mm, it is possible to obtain an advantageous effect of inhibiting the deformation of and the damage to the boss 120 while ensuring the sufficient strength and surface roughness of the boss 120 (preventing the slipping of the reinforcing material).

In the exemplary embodiment of the present invention illustrated and described above, there has been described the example in which the concave-convex pattern 122 is provided on the external surface of the boss 120 by the indentation process in the processing step S20. However, according to various exemplary embodiments of the present invention, the concave-convex pattern 122 may be provided on the external surface of the boss 120 by the cutting process.

Meanwhile, after the concave-convex pattern 122 is provided on the external surface of the boss 120, the boss 120 having the concave-convex pattern 122 may be integrally coupled to the end portion of the liner 110 (or integrated with the liner by injection molding) (see FIG. 2).

For example, the liner 110 may be made of a nonmetallic material such as high-density plastic with excellent restoring force and excellent fatigue resistance.

STEP 3:

Next, the reinforcing material 130 is wound around the external surface of the liner 110 including the boss 120 to be disposed on the concave-convex pattern 122 (S30).

In the winding step S30, a typical winding device may be used to wind the reinforcing material 130 around the external surface of the liner 110 so that the reinforcing material 130 is disposed on the concave-convex pattern 122 (see FIG. 2).

In the instant case, the configuration in which the reinforcing material 130 is disposed on the concave-convex pattern 122 may mean that the reinforcing material 130 is disposed such that at least a portion of the reinforcing material 130 covers the concave-convex pattern 122.

In the winding step S30, multiple layers of the reinforcing material 130 may be wound around the external surface of the liner 110 in various patterns (e.g., clockwise winding, counterclockwise winding, oblique winding, etc.), and the present invention is not restricted or limited by the method of winding the reinforcing material 130.

For example, the reinforcing material 130 may be wound around the external surface of the cylinder portion 112 first, and then wound around the external surface of the side portion 114 so that the reinforcing material 130 is disposed on the concave-convex pattern 122.

According to various exemplary embodiments of the present invention, the reinforcing material may be wound around the external surface of the side portion first, and then wound around the external surface of the cylinder portion.

Meanwhile, FIG. 2 illustrates the pressure vessel 100 having the reinforcing material 130 wound around the external surface of the liner 110. The reinforcing material 130 may be cured through the subsequent heat treatment process.

Meanwhile, in the exemplary embodiment of the present invention illustrated and described above, there has been described the example in which the concave-convex pattern is provided on the boss provided independently of the liner, and then the boss is coupled to the liner. However, according to various exemplary embodiments of the present invention, the concave-convex pattern may be provided on the boss in a state in which the boss and the liner are integrally coupled to each other.

According to various exemplary embodiments of the present invention, a method of manufacturing a pressure vessel may include: a preparation step of preparing the liner 110 having the boss 120 made of metal and provided at an end portion of the liner 110; a processing step of processing the concave-convex pattern 122 on the external surface of the boss 120; and a winding step of winding the reinforcing material 130 around the external surface of the liner 110 so that the reinforcing material 130 is disposed on the concave-convex pattern 122.

First, in the preparation step, the liner 110 having the boss 120 made of metal and integrally provided at the end portion of the liner 110 is provided (see FIG. 2).

Next, in the processing step, the concave-convex pattern 122 may be provided on the external surface of the boss 120 integrally provided at the end portion of the liner 110.

Thereafter, in the winding step, the reinforcing material 130 may be wound around the external surface of the liner 110 so that the reinforcing material 130 is disposed on the concave-convex pattern 122.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A method of manufacturing a pressure vessel, the method comprising:
preparing a boss made of metal;
processing a concave-convex pattern on an external surface of the boss; and
winding a reinforcing material around an external surface of a liner including the boss so that the reinforcing material is disposed on the concave-convex pattern.

2. The method of claim 1, wherein in the preparing a boss made of metal, the concave-convex pattern is provided by plastically deforming the external surface of the boss.

3. The method of claim 2, wherein the concave-convex pattern includes a plurality of crests and a plurality of troughs alternately disposed to define a continuous waveform therebetween.

4. The method of claim 3, wherein distances from a reference line, which is parallel to the external surface of the boss, to bottoms of the plurality of troughs are equal to one another.

5. The method of claim 3, wherein distances from a reference line, which is parallel to the external surface of the boss, to apices of the plurality of crests are equal to one another.

6. The method of claim 3, wherein distances from a reference line, which is parallel to the external surface of the boss, to apices of at least predetermined number among the plurality of crests are different from one another.

7. The method of claim 3, wherein a depth from the external surface of the boss to a bottom portion of the trough is 0.04 mm to 0.15 mm.

8. The method of claim 2, wherein in the processing a concave-convex pattern on an external surface of the boss, the concave-convex pattern is provided by pressing the external surface of the boss with indentation protrusions provided on a peripheral surface of an indentation jig.

9. The method of claim 8, wherein during the pressing the external surface of the boss with the indentation protrusions, the indentation jig rolls along the external surface of the boss or the boss rotates about an axis of the liner, and at least one of the rolling of the indentation jig and the rotation of the boss is performed.

10. The method of claim 2, wherein in the processing a concave-convex pattern on an external surface of the boss, the concave-convex pattern is provided by propelling shot balls against the external surface of the boss.

11. The method of claim 9, wherein the boss rotates about the axis of the liner during of the propelling the shot balls against the external surface of the boss.

12. The method of claim 1, wherein the boss is made of an aluminum alloy.

13. A pressure vessel comprising:
a liner having a boss made of metal and provided at an end portion of the liner;
a concave-convex pattern provided on an external surface of the boss; and
a reinforcing material wound around an external surface of the liner so that the reinforcing material is disposed on the concave-convex pattern.

14. The pressure vessel of claim 13, wherein the concave-convex pattern is provided by plastically deforming the external surface of the boss.

15. The pressure vessel of claim 14, wherein the concave-convex pattern includes a plurality of crests and a plurality of troughs alternately disposed to define a continuous waveform therebetween.

16. The pressure vessel of claim 15, wherein distances from a reference line, which is parallel to the external surface of the boss, to bottoms of the plurality of troughs are equal to one another.

17. The pressure vessel of claim 15, wherein distances from a reference line, which is parallel to the external surface of the boss, to apices of the plurality of crests are equal to one another.

18. The pressure vessel of claim 15, wherein distances from a reference line, which is parallel to the external surface of the boss, to apices of at least predetermined number among the plurality of crests are different from one another.

19. The pressure vessel of claim 15, wherein a depth from the external surface of the boss to a bottom portion of the trough is 0.04 mm to 0.15 mm.

20. The pressure vessel of claim 13, wherein the boss is made of an aluminum alloy.
